(19) United States
(12) Patent Application Publication
(10) Pub. No.: US 2006/0260505 A1
(43) Pub. Date: Nov. 23, 2006

(54) Aqueous dispersions of a pigment having improved freeze-thaw stability

(76) Inventors: Cheol Ham, Yongin-si (KR); Seung-min Ryu, Yongin-si (KR)

Correspondence Address: STANZIONE & KIM, LLP, 919 18TH STREET, N.W., SUITE 440, WASHINGTON, DC, 20006, US

(21) Appl. No.: 11/407,029

(22) Filed: Apr. 20, 2006

(30) Foreign Application Priority Data
May 19, 2005 (KR) 2005-42182

(51) Int. Cl. C09D 11/02; C09B 27/00; C08K 5/00; C09D 11/00; C09B 67/50; C09C 1/44

(52) U.S. Cl. 106/31.8; 106/31.75; 106/31.77; 106/31.78; 106/410; 106/472; 106/493; 106/496; 106/498

(57) ABSTRACT

An aqueous dispersion of a pigment having improved freeze-thaw stability. The aqueous dispersion includes an amino alcohol compound to increase dispersing action of a dispersant or dispersion stability of a self-dispersible pigment, thereby maintaining stable dispersion state after freezing and thawing from low temperature storage.

### CROSS-REFERENCE TO RELATED APPLICATIONS

This application claims priority under 35 U.S.C. §119(a) from Korean Patent Application No. 2005-42182, filed on May 19, 2005, in the Korean Intellectual Property Office, the disclosure of which is incorporated herein in its entirety by reference.

### BACKGROUND OF THE INVENTION

1. Field of the Invention

The present general inventive concept relates to an aqueous dispersion of a pigment having improved freeze-thaw stability, and more particularly, to an aqueous dispersion of a pigment having excellent freeze-thaw stability obtained by maintaining the dispersing action of a dispersant and the dispersion stability of a self-dispersible pigment.

2. Description of the Related Art

A pigment having excellent stiffness is widely used instead of a dyestuff as a colorant in an ink for a writing tool or an inkjet printer. A pigment is insoluble in water, unlike a dyestuff, and thus must be dispersed as a particulate in water. In general, in order to make pigment particles easily disperse in water and to prevent precipitation of the pigment particles, a method of micronizing a particle diameter of the pigment using various surfactants or aqueous resins, alone or in combination, and using a disperser, such as a sand grinder or a ball mill, is used. However, an aqueous dispersion of a pigment prepared from such a method can ensure dispersion stability from room temperature up to a high temperature, but cannot ensure satisfactory dispersion stability in an environment of cooling below room temperature, freezing, and thawing.

An aqueous dispersion of a pigment maintains a dispersed state by including a dispersant, and is widely used in an ink, a paint, etc. The dispersion is frequently exposed to a freezing-thawing condition during shipping or storage, and contains large amounts of water. Thus, when the dispersion is frozen and then thawed, solid precipitates are generated, and thus a dispersed state is not maintained because moisture and pigment particles are separated. Such a phenomenon is prone to occur in winter season or in a cold region. When the aqueous dispersion of a pigment is used in an ink or a related product, the freeze-thaw stability of the dispersion must be considered.

The mechanism by which the pigment particles are aggregated due to freezing-thawing is as follows. An ice crystal is formed due to a drop in temperature, and uniformly dispersed pigment particles are compressed due to large pressure generated by being confined in the crystal. The pigment particles strongly compressed due to freezing of the aqueous dispersion do not decompress even upon thawing, and are therefore not dispersed due to an aggregation of the pigment particles. Further, when a dispersant is also adsorbed on a surface of the pigment particles, strong aggregation occurs due to the aggregation of pigment particles upon freezing of the dispersion and due to an entanglement between the adsorbed dispersants. For self-dispersible pigment particles, the aggregation occurs due to the aggregation of self-dispersible pigment particles upon freezing of the dispersion and due to entanglement of parts of the hydrophilic groups of the self-dispersible pigment particles.

Japanese Patent Laid-Open No. 1996-73787 discloses an aqueous dispersion of a pigment that includes an alkali-soluble resin dispersant and a surfactant, and does not cause a change in a particle diameter of the pigment even after repeated freezing-thawing cycles. However, when adding the surfactant, much foam is generated and thus dispersion is not smoothly progressed. Further, a polymer-based surfactant has lower efficiency in freeze-thaw stability than that of a single molecule surfactant. In other words, the pigment particles are aggregated due to this freeze-thaw instability. Accordingly, such a dispersion of a pigment is not generally suitable for commercial use.

Meanwhile, U.S. Pat. No. 6,372,029 discloses a method of enhancing a freeze-thaw stability of an ink composition for an inkjet using at least one additive selected from the group consisting of a monosaccharide, a polysaccharide, glycerol, β-alanine, DL-alanine, betaine, dimethyl sulfoxide, polyvinyl pyrrolidone, and a combination and a derivative thereof. The additives prevent an ink composition from freezing even at low temperatures by lowering the freezing point of the ink composition.

### SUMMARY OF THE INVENTION

The present general inventive concept provides an aqueous dispersion of a pigment, the dispersion having excellent freeze-thaw stability that does not cause aggregation of pigment particles even upon thawing by preventing compression of the pigment particles even when the pigment particles are pressurized due to a growth of an ice crystal upon freezing and by preventing entanglement between hydrophilic groups of a dispersant located on a surface of the pigment or between surface groups of self-dispersible pigment particles.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an aqueous dispersion of a pigment, the dispersion comprising pigment particles, a dispersant, water, and about 0.1 to about 20 parts by weight of an amino alcohol compound based on 1 part by weight of the dispersant.

The foregoing and/or other aspects and utilities of the present general inventive concept may also be achieved by providing an aqueous dispersion of a pigment, the dispersion comprising self-dispersible pigment particles, water, and about 0.1 to about 10 parts by weight of an amino alcohol compound based on 1 part by weight of the pigment.

The amino alcohol compound may be at least one compound selected from the group consisting of ethanolamine, N,N-dimethylethanolamine, triethanolamine, 1-amino-2-propanol, 2-amino-1-propanol, 3-amino-1-propanol, 2-amino-1,3-propanediol, 3-methylamino-1,2-propanediol, 2-(aminoethyl)-2-ethyl-1,3-propanediol, 4-amino-2-butanol, 3-pyrrolidinol, 4-hydroxypiperidine, and 3-piperidinemethanol.

The pigment particles may be particles of a black pigment, a yellow pigment, a red pigment, or a blue pigment.

The foregoing and/or other aspects and utilities of the present general inventive concept may also be achieved by providing an aqueous dispersion, including at least one pigment, at least one amino alcohol compound, and an aqueous liquid vehicle. The aqueous dispersion may further include at least one dispersant. An amount of the dispersant in the aqueous dispersion may be about 0.05 to about 10 parts by weight based on 1 part by weight of the at least one pigment. An amount of the amino alcohol compound in the aqueous dispersion may be about 0.1 to about 20 parts by weight based on 1 part by weight of the dispersant. The at least one amino alcohol compound may be adsorbed as a zwitterion to one or more hydrophilic groups on a surface of the at least one dispersant. The at least one pigment may be a self-dispersible pigment. An amount of the amino alcohol compound in the aqueous dispersion is about 0.1 to about 10 parts by weight based on 1 part by weight of the self-disperible pigment. The at least one amino alcohol compound is adsorbed as a zwitterion to one or more hydrophilic groups on a surface of the self-dispersible pigment. The self-dispersible pigment may be at least one compound represented by formula I: 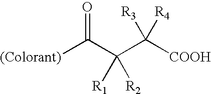
I, wherein R₁, R₂, R₃, and R₄ are compound selected from the group consisting of a hydrogen atom, a substituted or unsubstituted C1-C20 alkyl group, a substituted or unsubstituted C6-C20 aryl group, a substituted or unsubstituted C3-C20 heteroaryl group, a C2-C12 alkenyl group, a substituted or unsubstituted C7-C20 arylalkyl group, a halogen, NO₂, CN, or C1-C6 alkoxy. An amount of the amino alcohol compound in the aqueous dispersion may be about 1% to about 6% by weight of the amino alcohol compound based on 100% by weight of the dispersion. The liquid vehicle may comprise water. The liquid vehicle may comprise water and at least one co-solvent.

The foregoing and/or other aspects and utilities of the present general inventive concept may also be achieved by providing an inkjet ink composition, including an aqueous dispersion comprising at least one pigment, at least one amino alcohol compound, and an aqueous liquid vehicle. The inkjet ink composition may further comprise at least one additive selected from the group consisting of anti-clogging agents, polymeric additives, anti-kogation additives, anti-curl agents, humectants, biocides, anti-bleed agents, color-bleeding additives, colorants, inks, dyes, pigments, and pH buffering agents.

The foregoing and/or other aspects and utilities of the present general inventive concept may also be achieved by providing a method of making an aqueous dispersion comprising at least one pigment, at least one amino alcohol compound, and an aqueous liquid vehicle, the method comprising dispersing the at least one pigment together with the at least one amino alcohol compound in the aqueous liquid vehicle, and uniformly mixing the dispersion.

The foregoing and/or other aspects and utilities of the present general inventive concept may also be achieved by providing a method of making an aqueous dispersion comprising at least one pigment, at least one amino alcohol compound, and an aqueous liquid vehicle, the method comprising dispersing the at least one pigment in the aqueous liquid vehicle, dispersing the at least one amino alcohol compound in the aqueous liquid vehicle having the at least one pigment, and uniformly mixing the dispersion.

The foregoing and/or other aspects and utilities of the present general inventive concept may also be achieved by providing an inkjet printing method, comprising incorporating into an ink jet printing apparatus an ink composition comprising an aqueous dispersion comprising at least one pigment, at least one amino alcohol compound, and an aqueous liquid vehicle, and ejecting droplets of the ink composition in an image-wise pattern onto a substrate. The ink jet printing apparatus may comprise nozzles and uses a thermal ink jet process to selectively heat the ink composition in the nozzles and to eject droplets of the ink composition in the image-wise pattern. The ink jet printing apparatus may use an acoustic ink jet process to eject droplets of the ink composition in the image-wise pattern using acoustic beams.

### DETAILED DESCRIPTION OF THE PREFERRED EMBODIMENTS

These and/or other aspects and advantages of the present general inventive concept will become apparent and more readily appreciated from the following description of the embodiments.

The aqueous dispersion of a pigment according to an embodiment of the present general inventive concept can maintain stable dispersion state when stored at a low temperature for a long time or used at a low temperature, since the aqueous dispersion has excellent freeze-thaw stability due to the presence of an amino alcohol compound.

An aqueous dispersion of a pigment according to an embodiment of the present general inventive concept may include an aqueous dispersion of a pigment comprising pigment particles, a dispersant, water, and an amino alcohol compound.

An aqueous pigment dispersion according to another embodiment of the present general inventive concept may include an aqueous dispersion of a pigment comprising self-dispersible pigment particles, water, and an amino alcohol compound.

A cryoprotectant lowers a melting point of ice, and slows down growth of an ice crystal. The cryoprotectant has a strong affinity to water, and is capable of forming a hydrogen bond with a water molecule. Therefore, a molecular structure of the cryoprotectant is an important parameter to consider in determining a freeze-thaw stability effect of a dispersion containing the cryoprotectant.

Conventionally, when a polyhydric alcohol is added as a cryoprotectant, the freezing temperature of a pigment dispersion is lowered. However, if the dispersion is at a temperature below the lowered freezing temperature, the dispersion is frozen and the dispersion stability is decreased due to aggregation of pigment particles when the dispersion is thawed.

According to various embodiments of the present general inventive concept, pigment particles are coated by at least one amino alcohol compound adsorbed as a zwitterion (i.e., a molecule having both a positive and a negative charge) either to a hydrophilic group of an anion in a dispersant adsorbed to the pigment particles or to one or more hydrophilic groups of self-dispersible pigment particles. Accordingly, the aggregation of pigment particles coated by the amino alcohol compound does not occur even though an aqueous pigment dispersion containing the pigment particles is placed at a temperature below a freezing temperature of the dispersion, and does not occur even though a freezing-thawing cycle is repeated.

For a conventional dispersion of a pigment, an ice crystal is formed due to a drop in temperature, and uniformly dispersed pigment particles are compressed due to large pressure generated by being confined in the crystal. The pigment particles strongly compressed due to freezing of the aqueous dispersion do not decompress even upon thawing, and therefore are not dispersed due to aggregation of the pigment particles. Further, when a dispersant is adsorbed on a surface of the pigment particles, strong aggregation occurs due to the aggregation of pigment particles upon freezing of the dispersion and due to an entanglement between the adsorbed dispersants.

However, for a dispersion of a pigment according to an embodiment of the present general inventive concept, aggregation of pigment particles in the pigment dispersion is prevented by an amino alcohol compound adsorbed to a hydrophilic group of a dispersant or to a hydrophilic group of a self-dispersible pigment particle.

The amino alcohol compound may form a film on a surface of the pigment particles, and thus the action of the hydrophilic group of the dispersant or the self-dispersible pigment is not disturbed even upon thawing of the pigment dispersion. In particular, the amino alcohol compound may slow down the speed of ice crystal formation so that water gradually forms a crystal. Furthermore, the amino alcohol compound may prevent aggregation of the pigment particles resulting from compression by the crystal by maintaining a sterical structure on a surface of the dispersant or the self-dispersible pigment, even at or below the freezing temperature of water.

An aqueous dispersion of a pigment according to an embodiment of the present general inventive concept comprising non-self-dispersible pigment particles and a dispersant may comprise about 0.1 to about 20 parts by weight of an amino alcohol compound based on 1 part by weight of the dispersant. For example, the dispersion may comprise about 1 to about 10 parts by weight of an amino alcohol compound based on 1 part by weight of the dispersant, about 0.1 to about 5 parts by weight of an amino alcohol compound based on 1 part by weight of the dispersant, about 5 to about 20 parts by weight of an amino alcohol compound based on 1 part by weight of the dispersant, or about 5 to about 10 parts by weight of an amino alcohol compound based on 1 part by weight of the dispersant.

An aqueous dispersion of a pigment according to an embodiment of the present general inventive concept comprising self-dispersible pigment particles does not require a dispersant and may comprise about 0.1 to about 10 parts by weight of an amino alcohol compound based on 1 part by weight of the self-dispersible pigment particles. For example, the dispersion may comprise about 1 to about 8 parts by weight of an amino alcohol compound based on 1 part by weight of the self-dispersible pigment particles, about 0.1 to about 5 parts by weight of an amino alcohol compound based on 1 part by weight of the self-dispersible pigment particles, about 5 to about 10 parts by weight of an amino alcohol compound based on 1 part by weight of the self-dispersible pigment particles, or about 5 to about 8 parts by weight of an amino alcohol compound based on 1 part by weight of the self-dispersible pigment particles.

If the amount of the amino alcohol compound is too little, the amino alcohol compound is not a sufficient freeze-thaw stabilizer and thus the pigment particles will aggregate after freezing-thawing. If the amount of the amino alcohol compound is too much, a viscosity of the dispersion is increased, and a solubility of the dispersion is decreased, thereby lowering the stability of the dispersion. Further, ink compositions prepared from the dispersion in which the amount of the amino alcohol compound is too little or too much severely penetrate a paper substrate, and thus it becomes difficult to obtain a desired color density. Such ink compositions cannot be added in large amounts due to a decrease in a drying speed of the ink compositions.

An aqueous dispersion of a pigment according to an embodiment of the present general inventive concept may comprise about 1% to about 6% by weight of the amino alcohol compound based on 100% by weight of the dispersion. For example, the dispersion may comprise about 2% to about 6% by weight of the amino alcohol compound based on 100% by weight of the dispersion, or about 2.5% to about 5.5% by weight of the amino alcohol compound based on 100% by weight of the dispersion. Moreover, the dispersion may comprise about 3% by weight of the amino alcohol compound based on 100% by weight of the dispersion, about 3.5 by weight of the amino alcohol compound based on 100% by weight of the dispersion, about 4% by weight of the amino alcohol compound based on 100% by weight of the dispersion, about 4.5% by weight of the amino alcohol compound based on 100% by weight of the dispersion, about 5% by weight of the amino alcohol compound based on 100% by weight of the dispersion, or about 5.5% by weight of the amino alcohol compound based on 100% by weight of the dispersion.

The amino alcohol compound may be at least one compound selected from the group consisting of ethanolamine, N,N-dimethylethanolamine, triethanolamine, 1-amino-2-propanol, 2-amino-1-propanol, 3-amino-1-propanol, 2-amino-1,3-propanediol, 3-methylamino-1,2-propanediol, 2-(aminoethyl)-2-ethyl-1,3-propanediol, 4-amino-2-butanol, 3-pyrrolidinol, 4-hydroxypiperidine, and 3-piperidinemethanol.

When an amino alcohol compound is added to the aqueous pigment dispersion, the amino alcohol is uniformly dispersed therein. However, a method used to add the amino alcohol compound to the dispersion is not limited. That is, the amino alcohol compound can be added together with the pigment particles when dispersing pigment particles in water. Alternatively, the amino alcohol compound can be added when controlling the concentration of a dispersion after dispersing the pigment particles in the water. The dispersion may be thoroughly stirred in order to uniformly mix the dispersion, regardless of when the amine alcohol compound is added to the dispersion (e.g., with the pigment particles or after the pigment particles).

The dispersant may be any suitable water soluble resin or any suitable surfactants depending on the type of pigment particles used in the dispersion. The dispersant is used to enhance the dispersion of carbon black or a color pigment.

The water-soluble resin may be a synthetic polymer polymerized from one or more monomers selected from the group consisting of an unsaturated carboxylic acid (such as acrylic acid, methacrylic acid, maleic acid, itaconic acid, and the like), or an alkyl ester thereof, styrene, acrylonitrile, vinyl acetate, and an alkali metal salt, an ammonium salt, or an amine salt of the synthetic polymer.

The surfactant may include an anionic, a nonionic surfactant, or a combination of an anionic and a nonionic surfactant. Examples of the anionic surfactant include a sulfonate surfactant such as sulfosuccinate [e.g., Aerosol OT, A196, AY and GP available from CYTEC] and sulfonate [e.g., Aerosol DPOS-45 available from CYTEC; Witconate C-50H available from WITCO; Dowfax 8390 available from Dow]; and a fluoro surfactant [e.g., Fluorad FC99C available from 3M]. Examples of the nonionic surfactant include a fluoro surfactant [e.g., Fluorad FC170C available from 3M]; an alkoxylate surfactant [e.g., Tergitol series 15S-5, 15S-7 and 15S-9 available from Union Carbide]; and an organosilicon surfactant [e.g., Silwet L-77 and L-76-9 available from WITCO].

The self-dispersible pigment particles may be pigment particles in which a hydrophilic group is attached to a colorant particle. For example, the self-dispersible pigment particles may be pigment particles in which a diazonium base is reacted with a conventional carbon black. Furthermore, the self-dispersible pigment particles may be one or more compounds represented by formula I below, which is disclosed in Korean Patent Application No. 2004-98360:

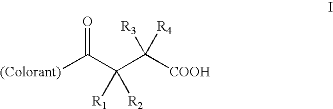

In the formula I, R₁, R₂, R₃, and R₄ may each independently be a hydrogen atom, a substituted or unsubstituted C1-C20 alkyl group, a substituted or unsubstituted C6-C20 aryl group, a substituted or unsubstituted C3-C20 heteroaryl group, a C2-C12 alkenyl group, a substituted or unsubstituted C7-C20 arylalkyl group, a halogen, NO₂, CN, or C1-C6 alkoxy. Thus, R₁-R₄ can all be the same group, can all be different groups, or at least two of R₁-R₄ can be the same or different groups. Furthermore, R₁ and R₂ can together form R₅—(R₆—)C═, wherein R₅, and R₆ are a hydrogen atom or a C1-C4 alkyl group. In addition, R₂ and R₃ can form a bond together.

An amount of a dispersant as a solid component may be in a range of about 0.05 to about 10 parts by weight based on 1 part by weight of the pigment particles.

The pigment particles may be, for example, particles of a black pigment, a yellow pigment, a red pigment or a blue pigment. Examples of the black pigment include aniline black or carbon black. For carbon black, an average particle diameter may be about 30 nm or less. Examples of the yellow pigment include an insoluble azo, an isoindolinone, a benzimidazolone, or a condensation azo based pigment. Examples of the red pigment include an insoluble azo, a quinacridone, or a perylene based pigment, Examples of the blue pigment include a phthalocyanine or a Christopher Wren based pigment.

An aqueous dispersion of a pigment according to an embodiment of the present general inventive concept can be prepared by adding pigment particles, a dispersant and other additives to water and simultaneously adding an amino alcohol to disperse, or adding pigment particles, a dispersant and other additives to water to disperse and then adding an amino alcohol when controlling the concentration of the resulting dispersion. For a self-dispersible pigment particle, it is not necessary to add a separate dispersant. Dispersing can be performed under high shear condition using a general dispersing equipment such as a medium disperser.

Although water is discussed above as being an aqueous liquid vehicle in the aqueous pigment dispersion, the present general inventive concept is not limited to water being the aqueous liquid vehicle. For example, the aqueous liquid vehicle can consist solely of water, or it can comprise a mixture of water and a water-soluble or water-miscible organic component.

An aqueous dispersion of a pigment according to an embodiment of the present general inventive concept can be used for preparing ink compositions, such as an ink composition for use in an inkjet printer and the like. Various embodiments of the ink compositions can also be used in conjunction with various ink additives including, but not limited to, anti-clogging agents, polymeric additives, anti-kogation additives, anti-curl agents, biocides, anti-bleed agents, color-bleeding additives, and pH buffering agents.

Embodiments of the ink compositions suitable for ink jet printing can be prepared by any suitable process. For example, the ink compositions can be prepared by simple mixing of the ingredients. All of the ink composition ingredients can be mixed together and filtered to obtain an ink. Alternatively, a subset of the ingredients can be mixed, heated if desired, and filtered, followed by adding any desired additional additives to the mixture and mixing at room temperature with moderate shaking until a homogeneous mixture is obtained.

### EXAMPLES

The present general inventive concept will be described in greater detail with reference to the following Examples and Comparative Examples. The following Examples and Comparative Examples are for illustrative purposes only and are not intended to limit the scope of the general inventive concept.

In the examples below, DISPERMAT®AE (from VMA-Getzmann GmbH) was used as a dispersing equipment. A dispersant, pigment particles, and an amino alcohol compound were mixed in water and a zirconium bead (average diameter=0.3 mm) was added. Then the mixture was dispersed at a speed of 10,000 rpm for 2 hours using the DISPERMAT®AE. The resulting product was filtered through a filter to obtain a pigment dispersion. In the Examples and Comparative Examples, % represents weight % based on 100% by weight of the respective dispersions.

In Example 1, the following components were used in the following amounts:

| | |
|---|---|
| Monarch 1300 (Cabot Company, Carbon black) | 15.0% |
| 1-amino-2-propanol | 4.5% |
| Edaplan 480 (Munzing Company, dispersant) | 16.5% |
| Deionized water | 64.0% |

After mixing the components with stirring, the mixture was dispersed in a disperser for 2 hours and filtered to obtain an aqueous dispersion of a black pigment.

In Example 2, the following components were used in the following amounts:

| | |
|---|---|
| Kronos 2300 (Kronos Company, Carbon black) | 15.0% |
| 3-amino-1-propanol | 3.6% |
| Joncryl 61 (Johnson Polymer Company, dispersant) | 15.0% |
| Deionized water | 66.4% |

After mixing the components with stirring, the mixture was dispersed in a disperser for 2 hours and filtered to obtain an aqueous dispersion of a black pigment.

In Example 3, the following components were used in the following amounts:

| | |
|---|---|
| Sipocal Yellow L 1100 (BASF Company, Yellow pigment) | 20.0% |
| 3-pyrollidinol | 5.0% |
| Edaplan 472 (Munzing Company, dispersant) | 5.0% |
| Deionized water | 70.0% |

After mixing the components with stirring, the mixture was dispersed in a disperser for 2 hours and filtered to obtain an aqueous dispersion of a yellow pigment.

In Example 4, the following components were used in the following amounts:

| | |
|---|---|
| Hostaperm Yellow H49 (Clariant Company, Yellow pigment) | 20.0% |
| 4-amino-2-butanol | 4.5% |
| Joncryl 62 (Johnson Polymer Company, dispersant) | 20.0% |
| Deionized water | 55.5% |

After mixing the components with stirring, the mixture was dispersed in a disperser for 2 hours and filtered to obtain an aqueous dispersion of a yellow pigment.

In Example 5, the following components were used in the following amounts:

| | |
|---|---|
| Irgazin Red 2030 (Ciba Company, Red pigment) | 20.0% |
| Triethanolamine | 4.0% |
| BYK 190 (BYK Company, dispersant) | 5.0% |
| Deionized water | 71.0% |

After mixing the components with stirring, the mixture was dispersed in a disperser for 2 hours and filtered to obtain an aqueous dispersion of a red pigment.

In Example 6, the following components were used in the following amounts:

| | |
|---|---|
| Chromophthal Violet B (Ciba Company, Red pigment) | 20.0% |
| 2-amino-1-propanol | 5.5% |
| Edaplan 480 (Munzing Company, dispersant) | 20.0% |
| Deionized water | 54.5% |

After mixing the components with stirring, the mixture was dispersed in a disperser for 2 hours and filtered to obtain an aqueous dispersion of a red pigment.

In Example 7, the following components were used in the following amounts:

| | |
|---|---|
| Hostaperm Blue B2G (Clariant Company, Blue | 20.0% |
| pigment) | |
| Ethanolamine | 5.5% |
| Edaplan 482 (Munzing Company, dispersant) | 10.0% |
| Deionized water | 64.5% |

After mixing the components with stirring, the mixture was dispersed in a disperser for 2 hours and filtered to obtain an aqueous dispersion of a blue pigment.

In Example 8, the following components were used in the following amounts:

| | |
|---|---|
| Heliogen Blue D 7080 (BASF Company, Blue | 20.0% |
| pigment) | |
| 3-piperidinemethanol | 4.7% |
| BYK 190 (BYK Company, dispersant) | 7.0% |
| Deionized water | 68.3% |

After mixing the components with stirring, the mixture was dispersed in a disperser for 2 hours and filtered to obtain an aqueous dispersion of a blue pigment.

In Example 9, the following components were used in the following amounts:

| | |
|---|---|
| Cabojet 300 (Cabot Company, self-dispersible Carbon black) | 12.0% |
| 1-amino-2-propanol | 4.7% |
| Deionized water | 83.3% |

After mixing the components with stirring, the mixture was filtered to obtain an aqueous dispersion of a black pigment.

In Comparative Example 1, an aqueous dispersion of a black pigment was obtained in the same method as in Example 1, except that glycerin was used instead of 1-amino-2-propanol.

In Comparative Example 2, an aqueous dispersion of a yellow pigment was obtained in the same method as in Example 3, except that ethylene glycol was used instead of 3-pyrrolidinol.

In Comparative Example 3, the following components were used in the following amounts:

| | |
|---|---|
| Chromophthal Violet B (Ciba Company, Red pigment) | 20.0% |
| 2-amino-1-propanol | 1.0% |
| Edaplan 480 (Munzing Company, dispersant) | 20.0% |
| Deionized water | 59.0% |

After mixing the components with stirring, the mixture was dispersed in a disperser for 2 hours and filtered to obtain an aqueous dispersion of a red pigment.

The aqueous dispersions of a pigment according to Examples 1 to 9, and Comparative Example 1 to 3 were stored in respective vials, and then subjected to a cycle of freezing at −20° C. for 18 hours, and then thawed at room temperature for 6 hours to observe changes in the pigments, e.g., a particle diameter of the pigments.

The aqueous dispersions of a pigment according to Examples 1 to 9 did not have any problems after 20 freezing-thawing cycles from −20° C. to room temperature. The aqueous dispersions of a pigment according to Comparative Examples 1 to 3 had aggregation of pigment particles in 9, 12, and 4 freezing-thawing cycles from −20° C. to room temperature.

Ink compositions comprising the aqueous pigment dispersions according to Examples 1 to 9, in which a pigment concentration was adjusted to be about 4% and a diethylene glycol concentration was adjusted to be about 6%, did not result in any problems in a printed image when the ink compositions were stored in an ink cartridge of the an inkjet printer (Samsung Electronic Company, MJC-3300P), and then printing was subsequently performed.

An aqueous dispersion of a pigment comprising an amino alcohol compound according to various embodiments of the present general inventive concept can be conserved in a low temperature environment since a particle diameter of the pigment is not changed even at a change in temperature condition, i.e., from room temperature to high temperature, and is not changed even after repeated freezing-thawing cycles. Thus, aqueous pigment dispersions comprising an amino alcohol compound according to various embodiments of the present general inventive concept can be suitably used in an ink composition useable in, for example, an inkjet printer or for a writing tool.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An aqueous dispersion of a pigment, the dispersion comprising:
pigment particles;
a dispersant;
water; and
about 0.1 to about 20 parts by weight of an amino alcohol compound based on 1 part by weight of the dispersant.

2. An aqueous dispersion of a pigment, the dispersion comprising:
self-dispersible pigment particles;
water; and
about 0.1 to about 10 parts by weight of an amino alcohol compound based on 1 part by weight of the pigment.

3. The aqueous dispersion of a pigment of claim 1, wherein the amino alcohol compound is at least one compound selected from the group consisting of ethanolamine, N,N-dimethylethanolamine, triethanolamine, 1-amino-2-propanol, 2-amino-1-propanol, 3-amino-1-propanol, 2-amino-1,3-propanediol, 3-methylamino-1,2-propanediol, 2-(aminoethyl)-2-ethyl-1,3-propanediol, 4-amino-2-butanol, 3-pyrrolidinol, 4-hydroxypiperidine, and 3-piperidinemethanol.

4. The aqueous dispersion of a pigment of claim 1, wherein the pigment particles are particles of a black pigment, a yellow pigment, a red pigment, or a blue pigment.

5. The aqueous dispersion of a pigment of claim 4, wherein the black pigment is aniline black or carbon black.

6. The aqueous dispersion of claim 5, wherein an average particle diameter of the carbon black is about 30 nm or less.

7. The aqueous dispersion of a pigment of claim 4, wherein the yellow pigment is an insoluble azo, an isoindolinone, a benzimidazolone, or a condensation azo based pigment.

8. The aqueous dispersion of a pigment of claim 4, wherein the red pigment is an insoluble azo, a quinacridone, or a perylene based pigment.

9. The aqueous dispersion of claim 4, wherein the blue pigment is a phthalocyanine or a Christopher Wren based pigment.

10. An ink composition comprising the aqueous dispersion of a pigment claim 1.

11. The ink of claim 10, wherein the ink is an inkjet ink useable in an inkjet printer.

12. An aqueous dispersion, comprising:
at least one pigment;
at least one amino alcohol compound; and
an aqueous liquid vehicle.

13. The aqueous dispersion of claim 12, further comprising at least one dispersant.

14. The aqueous dispersion of claim 13, wherein an amount of the dispersant in the aqueous dispersion is about 0.05 to about 10 parts by weight based on 1 part by weight of the at least one pigment.

15. The aqueous dispersion of claim 13, where an amount of the amino alcohol compound in the aqueous dispersion is about 0.1 to about 20 parts by weight based on 1 part by weight of the dispersant.

16. The aqueous dispersion of claim 13, wherein the at least one amino alcohol compound is adsorbed as a zwitterion to one or more hydrophilic groups on a surface of the at least one dispersant.

17. The aqueous dispersion of claim 12, wherein the at least one pigment is a self-dispersible pigment.

18. The aqueous dispersion of claim 17, where an amount of the amino alcohol compound in the aqueous dispersion is about 0.1 to about 10 parts by weight based on 1 part by weight of the self-dispersible pigment.

19. The aqueous dispersion of claim 17, wherein the at least one amino alcohol compound is adsorbed as a zwitterion to one or more hydrophilic groups on a surface of the self-dispersible pigment.

20. The aqueous dispersion of claim 17, wherein the self-dispersible pigment is at least one compound represented by formula I: 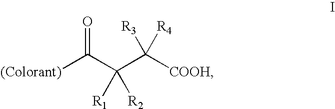
wherein R₁, R₂, R₃, and R₄ are compound selected from the group consisting of a hydrogen atom, a substituted or unsubstituted C1-C20 alkyl group, a substituted or unsubstituted C6-C20 aryl group, a substituted or unsubstituted C3-C20 heteroaryl group, a C2-C12 alkenyl group, a substituted or unsubstituted C7-C20 arylalkyl group, a halogen, NO₂, CN, or C1-C6 alkoxy.

21. The aqueous dispersion of claim 12, where an amount of the amino alcohol compound in the aqueous dispersion may be about 1% to about 6% by weight of the amino alcohol compound based on 100% by weight of the dispersion.

22. The aqueous dispersion of claim 12, wherein the liquid vehicle comprises water.

23. The aqueous dispersion of claim 12, wherein the liquid vehicle comprises water and at least one co-solvent.

24. An inkjet ink composition, comprising an aqueous dispersion comprising at least one pigment, at least one amino alcohol compound, and an aqueous liquid vehicle.

25. The inkjet ink composition of claim 24, further comprising at least one additive selected from the group consisting of anti-clogging agents, polymeric additives, anti-kogation additives, anti-curl agents, humectants, biocides, anti-bleed agents, color-bleeding additives, colorants, inks, dyes, pigments, and pH buffering agents.

26. A method of making an aqueous dispersion comprising at least one pigment, at least one amino alcohol compound, and an aqueous liquid vehicle, the method comprising:
dispersing the at least one pigment together with the at least one amino alcohol compound in the aqueous liquid vehicle; and
uniformly mixing the dispersion.

27. A method of making an aqueous dispersion comprising at least one pigment, at least one amino alcohol compound, and an aqueous liquid vehicle, the method comprising:
dispersing the at least one pigment in the aqueous liquid vehicle;
dispersing the at least one amino alcohol compound in the aqueous liquid vehicle having the at least one pigment; and
uniformly mixing the dispersion.

28. An inkjet printing method, comprising:
incorporating into an ink jet printing apparatus an ink composition comprising an aqueous dispersion comprising at least one pigment, at least one amino alcohol compound, and an aqueous liquid vehicle; and
ejecting droplets of the ink composition in an image-wise pattern onto a substrate.

29. The method of claim 28, wherein the ink jet printing apparatus comprises nozzles and uses a thermal ink jet process to selectively heat the ink composition in the nozzles and to eject droplets of the ink composition in the image-wise pattern.

30. The method of claim 28, wherein the ink jet printing apparatus uses an acoustic ink jet process to eject droplets of the ink composition in the image-wise pattern using acoustic beams.
